(19) United States
(12) Patent Application Publication
(10) Pub. No.: US 2013/0175127 A1
(43) Pub. Date: Jul. 11, 2013

(54) Friction plate

(71) Applicant: Winston MacKelvie, Knowlton (CA)

(72) Inventor: Winston MacKelvie, Knowlton (CA)

(21) Appl. No.: 13/694,639

(22) Filed: Dec. 19, 2012

Related U.S. Application Data
(60) Provisional application No. 61/630,803, filed on Dec. 19, 2011.

(51) Int. Cl. F16D 65/092

(52) U.S. Cl. CPC F16D 65/092
USPC 188/250 B

(57) ABSTRACT

The present invention is an improved disc brake plate wherein its two components, namely a steel backing plate and a friction plate or puck, are fabricated separately. The steel backing plate is stamped with a pattern of discrete protrusions rising from one face. The plates are cut from friction material extruded into any shape of rod or into a thick sheet after which they are impressed with a pattern of discrete recesses matching the backing plate's protuberances. The plates are then cured hard and finished as needed. An adhesive is used to bond the two components into a completed brake plate. In this way a wide range of vehicle brake plates can be assembled from separately prepared plates and backing plates.

### FIELD OF THE INVENTION

The present invention is in the field of disc (or disk) brakes for vehicles whereby a rotating disc (rotor) attached to a wheel, rotates through a very narrow gap between opposing disc brake pads held in a powerful hydraulic caliper. During braking, the brake pads move through the small gap to squeeze the rotor with enormous force, slowing the vehicle. Each disc brake pad comprises a steel backing plate with a friction plate attached to one face. During braking, enormous shearing forces are generated between the plates which is resisted by the adhesive and/or various mechanical means. The friction plate wears away with each application of the brakes.

### BACKGROUND OF THE INVENTION

The present invention is for an improved disc brake pad to provide lower cost, longer wearing and safer braking in vehicles.

### SUMMARY OF THE INVENTION

A method of making brake pads comprising the steps of making backing plates and friction plates with complimentary engagement features and then bonding them together with adhesive.

In the plate of the present invention, a discrete pattern of discrete protuberances is provided one face of said backing plate. Protuberances may include such shapes as pins, hooks, burrs, bristles, knurls, ridges, rings and the like. Preferably the discrete protrusions form a discrete pattern. Preferable the discrete pattern of discrete protuberances is repeated at different locations on the plate.

Friction mixture is formed into friction plates which may be of various shapes such as disc-like pucks. A matching discrete pattern of recesses are formed in each friction plate or puck. The friction plates are then cured (made hard) ready to be mated and adhesively bonded to the plate.

Preferably the protrusions on the plate are short so as to maximize the life of the friction plate before wear exposes their tips for unwanted contact with the rotor.

The protrusions may also be added to the plate as weldments, by, for example, stud welding techniques or by attaching an appropriately shaped material such as spheres, beads, wire, meshes, metal wools, or bristles, to the plate. Separately formed sheet metal having the necessary protuberances may also be attached to the plate by, for example, spot welding.

In one embodiment, friction plates may be cut from a large, pre-made plate of brake friction material using a laser, mill, or waterjet to cut the final contours.

In another embodiment, if the lining is made into plate for cookie-cutting the friction plates therefrom, the plate can be formed in layers of different friction compositions such as gradients of hardness. For example the thermal conductivity may be increased by having a more metallic composition near the plate and less near the rotor face. In this way the thinning friction plate can offer driver safety through better management of the different stages of friction plate wear.

In all cases, the friction plate and plate have complimentary mating features. The features should be fully contained within the perimeter of the friction plate so that the adhesive forms a surrounding seal that will prevent the ingress of water which could disadvantageously lead to interfacial rusting and then, almost certainly, to delamination.

The engagement of plate friction plate-to-plate may be such that an assembly force may preferentially be required. The recess walls may, for example, be lightly engaged by the plate's protuberances. The recess can be made slightly deeper than necessary to accommodate the sheared of puck material in the resulting pocket at the top of each post.

The adhesive applied to the friction plate and/or backing friction plate may be of a heat curing formula whereby the adhesive may be pre-applied as liquid and then dried. After assembly heating cures the adhesive. The adhesive necessarily forms a thin layer between friction plate and backing plate and thus can serve a secondary valuable function—that of a noise, harshness, vibration (NHV) dampening medium. The adhesive layer may be increased in thickness to improve its NHV dampening by incorporating particles such as glass beads to prevent too-intimate face-to-face contact between the plates.

Further, the features on the plate and friction plate could be reversed such that the plate has recesses and the friction plate has protuberances. For example, the plate may have circular depressions and the friction plate raised plateaus that engage the depressions.

In yet another embodiment, a combination of recesses and protuberances may be formed on each component.

In this way the myriad range of vehicular plate designs can all be fitted from a range of ‘stock’ friction plate in contrast to the slow, messy, and expensive current batch manufacturing process.

### BRIEF DESCRIPTION OF THE DRAWINGS

Having thus generally described the invention, reference will be made to the accompanying drawings illustrating an embodiment thereof, in which:

FIGS. 1, 2 and 3 shows the Prior Art; a backing plate with a bonded on, one-piece lining and showing other features sometimes present;

FIGS. 4, 5, and 6 shows the same plate design but with separate friction plates mechanically engaged and adhesively bonded; the pattern of protrusions and recesses are shown to have a radial symmetry such that assembly is not dependent on a friction plate's radial orientation or position;

FIG. 7 shows detail of the plate and two friction plates where a pattern of recesses on a first face of the lining line up to mate with a like pattern of post-style protrusions on the first face of the plate;

FIG. 8 shows variations of protrusions which may be the preferred hooks on the upper portion of the plate and ridges or burrs, pins, dimples, ridges, or knurl, and the matching engagement recesses;

FIG. 9 shows the second face of the backing plate and the punch marks left from the extrusion of pin-like protrusions on the opposite first face where the lining will be attached;

FIG. 10 shows another variation on the upper portion of the backing plate where a grid of wire mesh is welded to a face and a matching grid of recesses on the lining allow their engagement; on the lower portion is shown knurls (pyramid shaped) raised features formed in the preferred circular pattern for easy assembly of the matching friction plates (not shown) thereon;

FIG. 11 shows other multiple friction plate shapes;

FIG. 12 shows a one-piece friction plate based on the present invention and where multiple groups of engagements are provided;

FIG. 13 shows another embodiment where a single, larger recess in the friction plate encloses multiple protrusions, such as the preferred raised hook or burr shown, and how this arrangement is repeated in different locations on the lining and plate;

FIG. 14 shows the same embodiment in a side view;

FIG. 15 shows an extruded rod of compacted friction material and multiples of individual friction plate sliced therefrom; and

FIG. 16 shows multiple friction plates that are cookie-cut from a sheet of compacted friction material.

### DETAILED DESCRIPTION OF THE INVENTION

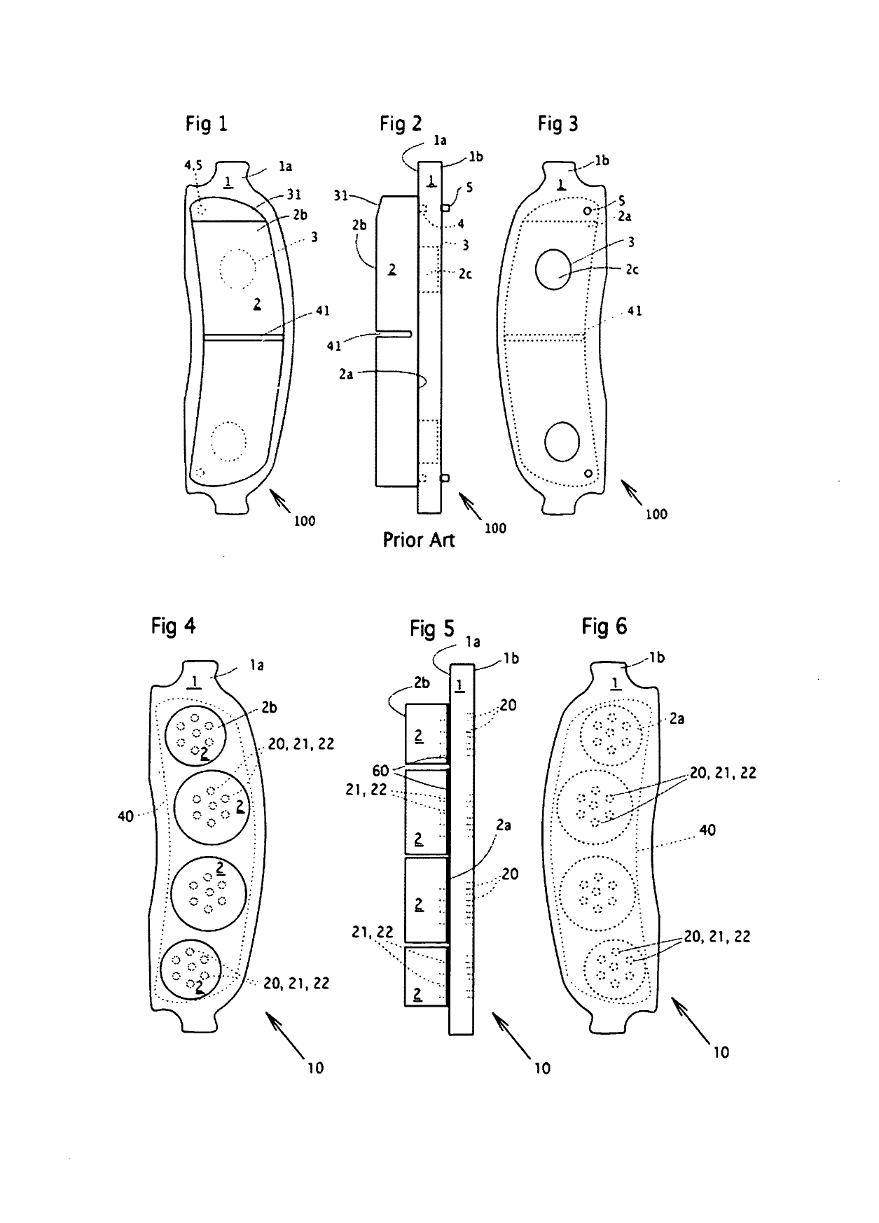

Referring to the drawings, FIGS. 1-3 depict a Prior Art disc brake pad 100. FIG. 1 is the front view of the second face 2b of friction plate 2 which is the face that contacts the disc brake rotor. FIG. 2 is a side view of the same embodiment showing the first and second faces, 2a and 2b respectively of lining 2 and, first and second faces 1a and 1b respectively of the friction plate and backing plate 1. FIG. 3 is a back view of brake pad 100 where is shown the second face 1b of the backing plate 1 that contacts the caliper piston and/or anvil.

In the Prior Art the first face 2a of the one-piece backing plate 2 is bonded during molding to the first face 1a of the backing plate 1. Features such as holes 3 in the face 1a of backing plate 1 are filled with lining material 2c during the molding process and serves to help anchor the lining to the backing plate. This particular Prior Art brake pad has an auxiliary feature in the form of a locator pin 5 protruding from the second face 1b of backing plate 1, although this is not present on all designs of disc brake pads, its inclusion here is for reference and show how pin 5 has been formed by punch-extrusion from the second face 1b of backing plate 1. The pin-shaped punch has left a cavity 4 in the surface of the second face that has a shape and volume very similar to the shape and volume of pin 5. Having no purpose on the first face Cavity 4 is covered over by lining 2. Its function may be to locate certain pieces such as anti-rattle clips when the brake pad is installed in a caliper.

Other features known to exist on Prior Art backing plates 1 include raised hooks, weldments, ridges and the like. However these are all designed for embedment in the flowable friction material during the molding operation previously described.

Prior Art brake pad linings 2 may also include features such as grooves 41 and chamfers 31 to manage harshness, noise, and vibration (HNV) and for thermal and dust control.

In summary the Prior Art disc brake pad comprises a steel backing plate which may have certain raised or recessed features such as hooks, pins and holes 3 on its first face 1a, and, a lining 2 which is pressure- and temperature molded from flowable friction material onto the first face 1a of backing plate 1 and into or about any such features which become embedded or filled 2c by it.

In the disc brake pad of the present invention, the backing plate 1 and friction plate 2 are produced separately and the first face 1a of backing plate 1 and first face 2a of friction plate 2 are provided with a complimentary pattern of features that can interdigitate, interlock, engage, mate or plug together. An adhesive 60 (shown only in FIG. 5) is provided on either or both first faces 1a, 2a, including in and on their respective interlocking features (not shown). The backing plate and friction plate are then brought together and the adhesive is cured to permanently secure the friction plate to the backing plate resulting in a novel brake pad.

FIGS. 4, 5 and 6 show this inventive brake pad 10 in the same view configurations as the Prior Art described above but with multiple friction plates 2, in this case circular ones. Recesses 20 are on first face 2a of friction plate 2, protuberances 21 are on first face 1 a of backing plate 1, and cavities 20 are on second face 1b of backing plate 1. Punch-pin cavities 20 do not have any operative function but are remnants of the punch that created (one form of) protuberances 21.

In FIGS. 4-6 all the protuberances are pin-or post-like structures shown punch-extruded from second face 1b resulting in cavities 20 in second face 1b. The four friction plates 2 are shown to be cylindrical, such a shape being the simplest and cheapest to manufacture in that they can be sliced like bread from a continuously extruded rod of friction material 46. These friction plates 2 can be made in a variety of diameters to enable a best-fit to a wide range of backing plate 1 shapes and sizes. The first face of the uncured lining is pressed onto an appropriate form, such as a pattern of tapered pins, so as to create the shallow recesses 22. After curing hard the friction plates are then ready for further processing such as grinding to finished size or application of adhesive.

In FIGS. 4-6 dashed line 30 represents the friction plate outline of the Prior Art lining. The friction plates 2 are nested together so as to be within the required area indicated by line 30. As can be appreciated the shape and number of friction plate 2 can be whatever is required in terms of cost and total area contacting the disc brake rotor (not shown).

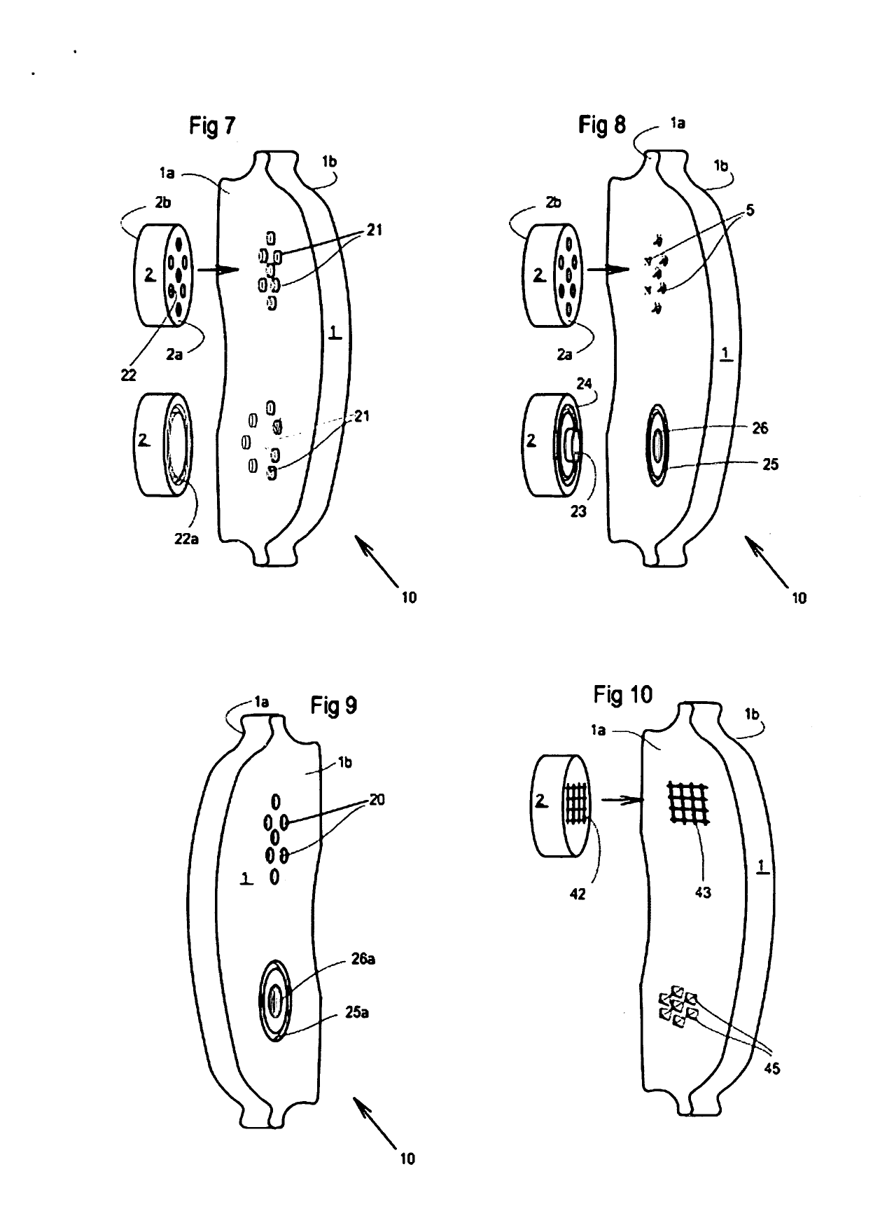

FIG. 7 shows a pre-assembly view of the two first faces of backing plate and friction plate 1a, 2a with their respective protuberances 21 and recesses 22. The recesses are such that the backing plate and friction plate fully engage allowing the face surfaces to contact each other where minimum adhesive thickness is specified. Circular ring groove 22a can advantageously be used to speed assembly since a ring shape will receive a ring of protuberances 21 without radial alignment.

FIG. 8 shows a preferred embodiment where a pattern of hook-like burrs 5 are raised directly from first face 1a of backing plate 1 and only in areas covered by the friction plate. On the same backing plate is shown another form of mating where the backing plate 1 has a recessed ring 25 and a centered recess 26. They mate with raised groove shape 24 and plug shape 23 respectively on friction plate 2.

FIG. 9 shows how the backing plate 1 may have the recesses 25a and 26a to mate with raised features on the friction plate (not shown).

FIG. 10 shows how a weldments such as the a wire mesh 43 shown on backing plate 1 may be mated with a complimentary pattern of recesses 42 on friction plate 2. Also show in FIG. 10 are knurl protrusions 45 which are pyramid-shaped features often used to provide grip on surfaces (matching friction plate not shown);

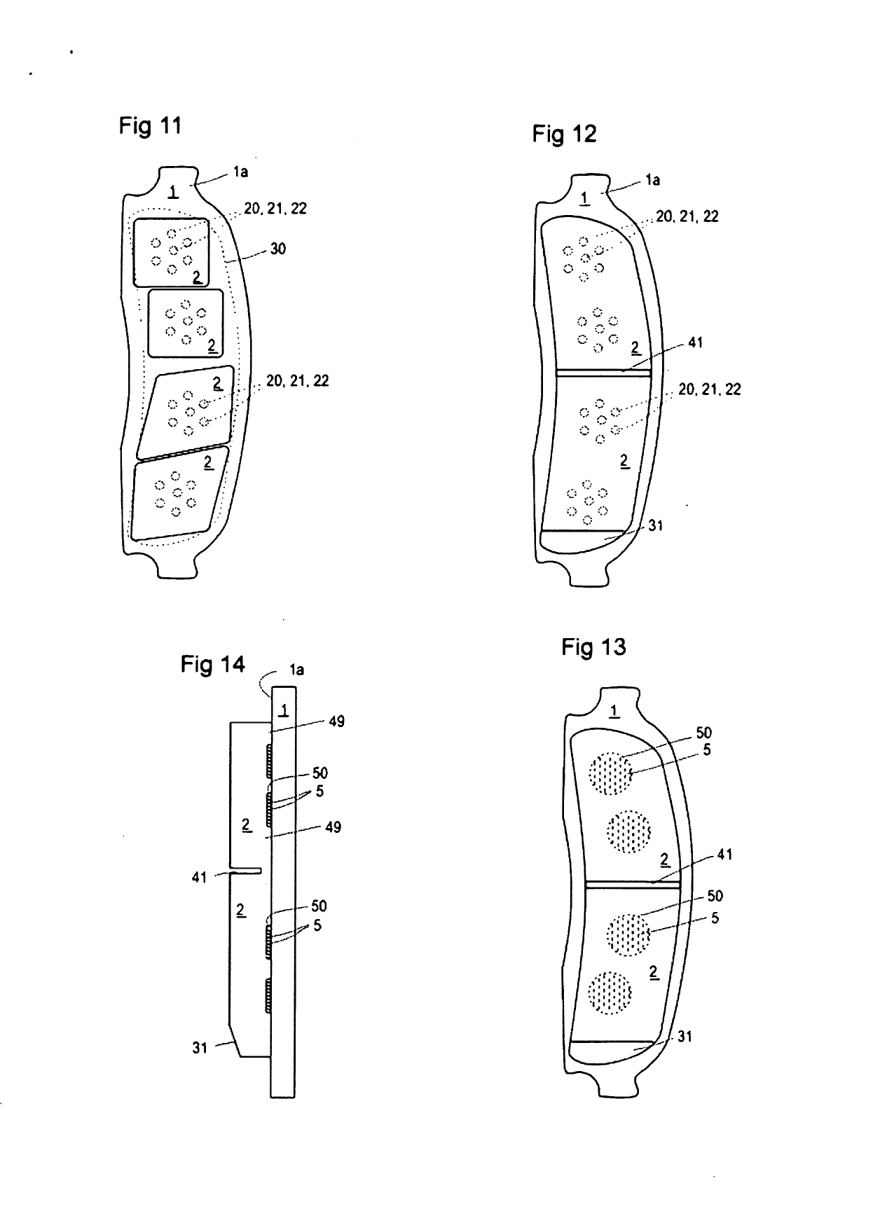

FIG. 11 shows different shapes of friction plates 2 that maximize coverage within line 30 that represents the Prior Art friction plate area.

FIG. 12 shows another embodiment where a single friction plate 2 has four separate areas of mating structures. Friction plate 2 is shown as being one piece but may be two or any number.

FIG. 13 shows another embodiment where recesses 50 in friction plate 2 are large enough to enclose a multitude of burrs 5. The burrs are shown to have been formed in a pattern as would result from a plurality of parallel toothed blades used to raise the burrs. The recess would be filled with adhesive on assembly. FIG. 14 shows the same embodiment in side view. With this embodiment multiple friction plates could each have one or more large recess(es) each recess encompassing a multitude of backing plate protrusion burrs 5.

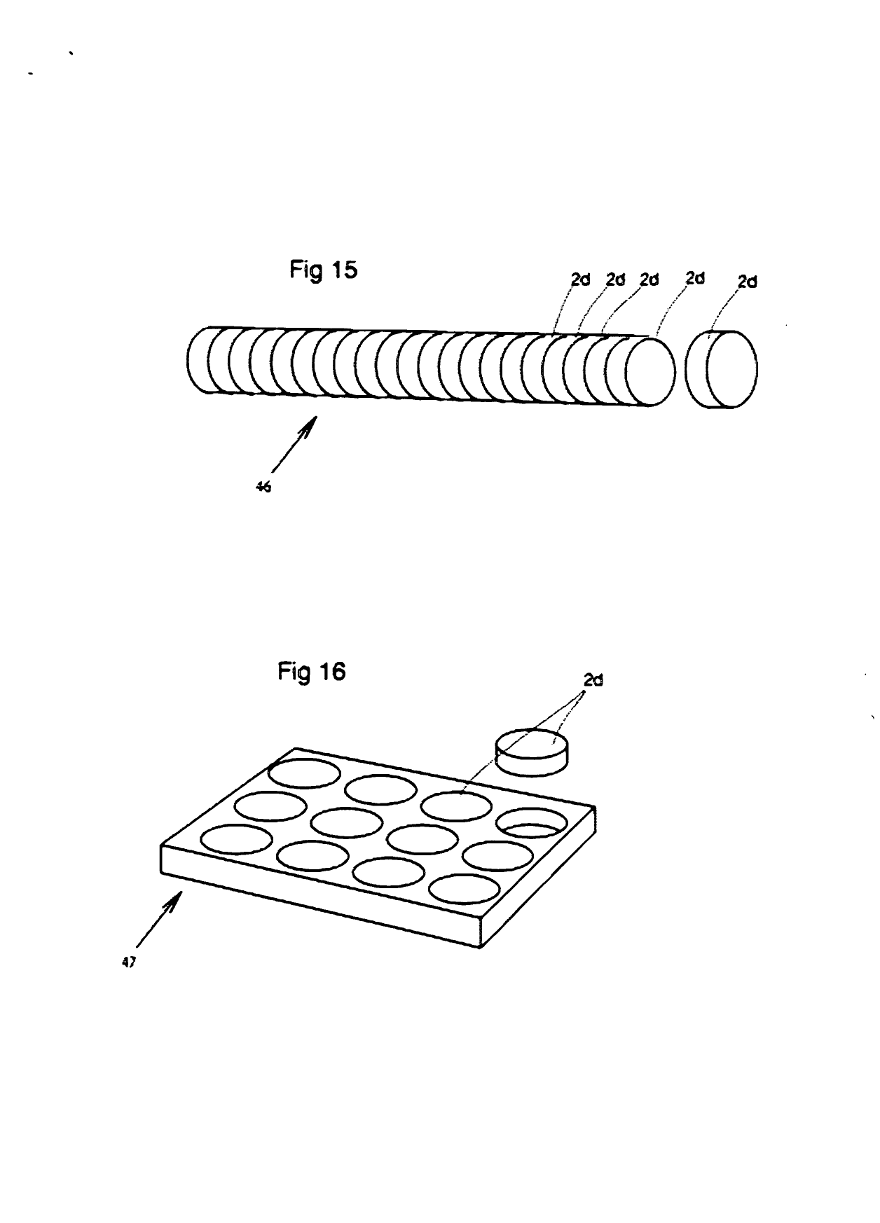

FIG. 15 shows a rod-shaped circular extrude 46 from which multiple friction plates 2 are sliced while FIG. 16 shows a molded or extruded sheet backing plate 47 for cookie-cutting multiple friction plates 2.

The present invention should become mandated in the interest of everyone's safety.

It will be appreciated that any combination of the embodiments herein described can be used as may be required for a safe, low-cost brake.

I claim:

1. In a disc brake plate comprising a backing plate with friction plate secured thereto, the improvement comprising:
one of said backing plate and said friction plate having at least one discrete protrusion arranged in a discrete pattern;
the other of said friction plate and said backing plate having at least one discrete recess to engage at least one said discrete protuberance; and
said at least one recess mating with said at least one discrete protuberance so as to reinforce the securing of said friction plate to said backing plate.

2. The improvement of claim 1 wherein said backing plate has a plurality of said discrete protrusions and said friction plate has a plurality of discrete recesses.

3. The improvement of claim 2 where said discrete protrusions arranged in said discrete pattern are provided at multiple discrete locations on said backing plate, and where each of said discrete locations receive said friction plate.

4. The improvement of claim 3 where one said discrete recess in said friction plate is provided for each said discrete protrusions on said backing plate.

5. A disc brake pad comprising a backing plate with a discrete pattern of discrete protrusions arranged in multiple locations, and a friction plate for each said location each having discrete recesses to engage said protrusions.
